(19) United States
(12) Patent Application Publication
(10) Pub. No.: US 2026/0064589 A1
(43) Pub. Date: Mar. 5, 2026

(54) STORAGE DEVICE AND OPERATING METHOD THEREOF

(71) Applicant: Samsung Electronics Co., Ltd., Suwon-si (KR)

(72) Inventors: Kyungduk LEE, Suwon-si (KR); Youhwan KIM, Suwon-si (KR); Jooyong PARK, Suwon-si (KR); Hoseong AHN, Suwon-si (KR)

(73) Assignee: Samsung Electronics Co., Ltd., Suwon-si (KR)

(21) Appl. No.: 19/301,420

(22) Filed: Aug. 15, 2025

(30) Foreign Application Priority Data
Aug. 29, 2024 (KR) 10-2024-0116629

(51) Int. Cl. G06F 12/02

(52) U.S. Cl. CPC G06F 12/0246; G06F 2212/7211

(57) ABSTRACT

Disclosed is a storage device which includes a nonvolatile memory device that includes a plurality of memory blocks and stores or reads data, and a controller that controls the nonvolatile memory device and executes a data input/output request provided from a host. Each of the plurality of memory blocks includes a first sub-block and a second sub-block, and the controller determines whether data of the second sub-block are degraded, based on the number of times of an operation performed in the first sub-block.

### CROSS-REFERENCE TO RELATED APPLICATIONS

This application claims priority under 35 U.S.C. § 119 to Korean Patent Application No. 10-2024-0116629 filed on Aug. 29, 2024, in the Korean Intellectual Property Office, the disclosures of which are incorporated by reference herein in their entireties.

### BACKGROUND

Embodiments of the present disclosure described herein relate to a storage device and an operating method thereof.

The amount of data is increasing as artificial intelligence (AI) and autonomous driving are commercialized. Therefore, demand for increased storage capacity of data centers is also continuously increasing, and services of the data center are also evolving. As a semiconductor device-based storage device offers high input/output (I/O) performance and low energy consumption compared to a hard disk drive (HDD), the use of the semiconductor-based nonvolatile memory device is being used as a storage device in a data center and a cloud computing environment where multiple users share resources.

Additionally, to cope with the increased demand, three-dimensional memory devices with the high degree of integration are being used as storage spaces.

### SUMMARY

Embodiments of the present disclosure are intended to reduce or prevent the degradation of performance due to the disturb caused in a block or a sub-block when an operation on the sub-block is performed, in a semiconductor-based storage device.

According to at least one embodiment, a storage device may include a nonvolatile memory device including a plurality of memory blocks, the nonvolatile memory device configured to store and read data, and a controller configured to control the nonvolatile memory device and to execute a data input request and a data output based on requests provided from a host. Each of the plurality of memory blocks may include at least a first sub-block and a second sub-block, and the controller may be configured to determine whether data of the second sub-block are degraded, the determination based on the number of times an operation is performed in the first sub-block.

According to at least one embodiment, a storage device may include a memory device that includes a plurality of memory blocks, and a controller that controls the memory device. Each of the plurality of memory blocks may include a plurality of sub-blocks, and the controller may be configured to determine whether data of a sub-block, from among the plurality of sub-blocks, are degraded based on a number of times an operation is performed on another sub-block from among the plurality of sub-blocks.

According to at least one embodiment, an operating method of a storage device may include checking an operation requested to be performed in a first sub-block, changing, when the operation is one of preset operations, a value, representing a number of times the operation is performed in associated with the first sub-block, in a table, and determining whether data of a second sub-block are degraded based on the number of times the operation associated with the first sub-block is performed. The first sub-block and the second sub-block may separate sub-blocks included in a same block.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a storage device according to at least one embodiment of the present disclosure.

FIG. 2 is a diagram describing the disturb caused in any other sub-block due to a program/erase operation of any sub-block as an example.

FIG. 3 is a diagram illustrating a software architecture of a storage device of FIG. 1.

FIG. 4 is a block diagram describing at least one embodiment of a memory controller of FIG. 1.

FIG. 5 is a diagram describing a configuration according to at least one embodiment of a memory device of FIG. 1.

FIG. 6 is a diagram illustrating a configuration of a memory device of FIG. 1.

FIG. 7 is a diagram illustrating at least one embodiment of a configuration of a row decoder of a memory device of FIG. 6.

FIG. 8 is a diagram describing a configuration of memory blocks according to at least one embodiment of a memory device of FIG. 1.

FIG. 9 is a diagram illustrating memory cells constituting a memory block according to at least one embodiment of a memory device of FIG. 1.

FIG. 10 is a block diagram describing at least one embodiment of a memory controller of FIG. 1.

FIG. 11 is a diagram describing a configuration according to at least one embodiment of a CDC table.

FIG. 12 is a diagram describing a method of updating a CDC table of FIG. 11.

FIG. 13 is a diagram describing a configuration according to at least one embodiment of a CDC table.

FIG. 14 is a diagram describing a method of updating a CDC table of FIG. 13.

FIG. 15 is a diagram describing a configuration according to at least one embodiment of a CDC table.

FIGS. 16 and 17 are diagrams describing a method of updating a CDC table of FIG. 15.

FIG. 18 is a diagram describing a configuration according to at least one embodiment of a CDC table.

FIG. 19 is a diagram describing a method of updating a CDC table of FIG. 18.

FIG. 20 is a diagram describing an operating method of a storage device according to at least one embodiment of the present disclosure.

### DETAILED DESCRIPTION

Below, example embodiments of the present disclosure will be described in detail and clearly to such an extent that an ordinary one in the art easily carries out the present disclosure. The example embodiments will be described in detail with reference to the accompanying drawings. When describing the example embodiments with reference to the accompanying drawings, like reference numerals refer to like elements and a repeated description related thereto will be omitted. Additionally, unless indicated otherwise, functional elements that process at least one function or operation may be implemented in processing circuitry such as hardware, software, and/or a combination of hardware and software. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc., and/or electronic circuits including said components.

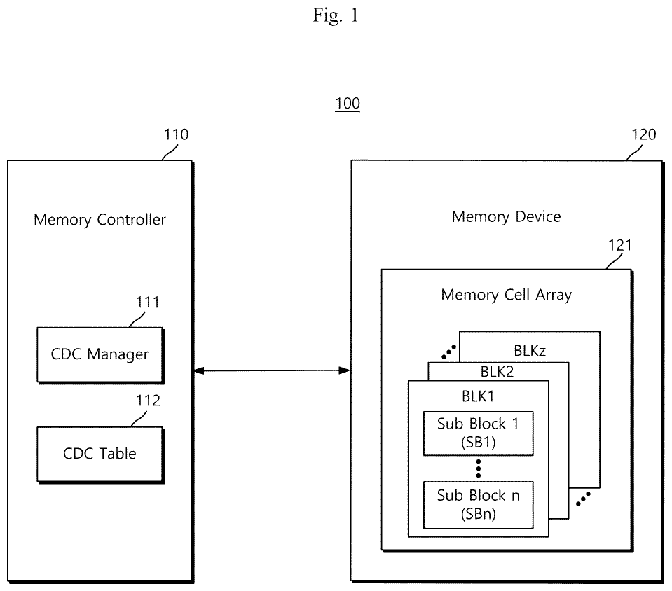

FIG. 1 is a block diagram illustrating a storage device 100 according to at least one embodiment of the present disclosure.

The storage device 100 according to at least one embodiment of the present disclosure is configured to compensate for a disturb (or disturbance) caused in a first sub-block due to the execution of an operation on a second sub-block, in each memory block including a plurality of sub-blocks. For example, when the disturb caused in the sub-block reaches a given reference (e.g., a tolerance threshold reference), the storage device 100 may determine whether the sub-block is degraded.

The following description will be given in detail with reference to FIG. 1. Referring to FIG. 1, the storage device 100, according to at least one embodiment, includes a memory controller 110 and a memory device 120.

The storage device 100 may be an internal memory embedded in an electronic device. For example, the storage device 100 may include a solid state drive (SSD), an embedded universal flash storage (UFS) device, an embedded multi-media card (eMMC), and/or the like.

Alternatively, the storage device 100 may be an external storage device configured to be removable from an electronic device. For example, the storage device 100 may include a UFS memory card, a compact flash (CF) card, a secure digital (SD) card, a micro-SD card, a mini-SD card, an extreme digital (xD) card, a memory stick, and/or the like.

However, these are only provided as an example. According to at least one embodiment, the storage device 100 may be and/or may be included in a “personal computer”, a “data center”, “network attached storage” (NAS), an “Internet of Things (IoT) device”, a “portable electronic device”, etc.

The storage device 100 may be electrically connected to a host (not illustrated) so as to be used by the host, and the storage device 100 may be configured to be accessed through a direct media access (DMA) of another device in addition to the host.

The storage device 100 may be implemented in a state of being physically separated from the host or may be implemented with the form factor mounted on the same package as the host. For example, the storage device 100 may be implemented based on the E1.S, E1.L, E3.S, E3.L, peripheral component interconnect express (PCIe) add in card (AIC) (CEM), and/or the like form factor. Alternatively, the storage device 100 may be implemented based on the U.2 form factor, the M.2 form factor, or any other PCIe form factor.

The storage device 100 may be coupled such that communication with any other components of the host in enabled through a storage interface bus. For example, according to at least one embodiment, the storage device 100 may be directly mounted on a physical port which is based on the peripheral component interconnect express (PCIe). The storage interface bus may be, for example, a PCIe bus. The host may exchange data with the storage device 100 through the storage interface bus by using a storage interface protocol. The data may include user data. The storage interface protocol may be, for example, a compute express link (CXL) protocol and/or a non-volatile memory host controller express (NVMe) protocol.

The memory controller 110 may control the memory device 120 to perform a request received from the host. The request may include a request for a write operation, a read operation, and/or an erase operation of user data. The write operation may also be referred to as a “record, store, and/or program operation.” In the specification, the expression “the memory controller 110 programs data” is used as having the same meaning as the memory controller 110 controls the memory device 120 to program data in the memory device 120. The data may be user data or may be another pattern data.

The memory device 120 may include a nonvolatile memory device. The memory device 120 may include a flash memory of a two-dimensional (2D) structure or a two-dimensional (3D) structure. The flash memory may include different kinds of nonvolatile memories such as a NAND flash memory, a vertical NAND (V-NAND) flash memory, a NOR flash memory, a magnetic RAM (MRAM), a phase-change RAM (PRAM), a ferroelectric random access memory (FRAM), a spin transfer torque random access memory (STT-RAM), a resistive RAM (RRAM), any combination therefore, and/or the like.

The memory controller 110 may control the memory device 120 depending on a request of an external device (e.g., a host). For example, the memory controller 110 may transmit an address and a command to the memory device 120 depending on the request of the external device. The memory controller 110 may exchange data with the memory device 120 depending on the request of the external device.

The memory device 120 may include a memory cell array 121, and the memory cell array 121 may include a plurality of blocks BLK1 to BLKz. Each of the plurality of blocks BLK1 to BLKz may include a plurality of memory cells. Each of the plurality of memory cells may be a single level cell (SLC) storing 1-bit data or may be a multi-level cell (MLC) storing 2-bit data. Alternatively, each of the plurality of memory cells may be a triple level cell (TLC) storing 3-bit data or may be a quadruple level cell (QLC) storing 4-bit data, etc. In other words, the size of data stored in a memory cell are provided as examples, and a memory cell may store various sizes of bit data.

Each of the plurality of blocks BLK1 to BLKz may include a plurality of sub-blocks SB1 to SBn. In at least one embodiment, the sub-block may mean a minimum unit by which an erase operation is capable of being performed. For example, the memory device 120 may perform the erase operation in units of sub-block. However, this is provided as an example. According to at least one embodiment, the memory device 120 may perform the erase operation in units of block.

The plurality of blocks BLK1 to BLKz may have the same size. According to at least one embodiment, a super block including a plurality of blocks may be implemented. A block or a super block may be used, for example, as a data management unit of a normal I/O operation such as a write operation or a read operation.

In at least one embodiment, the plurality of sub-blocks SB1 to SBn may have different sizes. For example, due to a characteristic of a physical structure of each block, the plurality of sub-blocks SB1 to SBn may have different sizes. As another example, in the process of dynamically setting the plurality of sub-blocks SB1 to SBn in each block, the plurality of sub-blocks SB1 to SBn may be set to have different sizes. However, this is provided as an example. According to at least one embodiment, the plurality of sub-blocks SB1 to SBn may be implemented to have the same size.

In at least one embodiment of the present disclosure, the memory controller 110 may include a cycle disturb count (CDC) manager 111 and a CDC table 112.

The CDC manager 111 may generate or change the CDC table 112 based on an operation performed in any other sub-block of a memory block. The CDC table 112 may include information about the number of times of disturb and/or information about the number of times of an operation causing the disturb. The CDC table 112 may also be referred to as a “disturb table”.

For example, the first block BLK1 may include the plurality of sub-blocks SB1, SBn. When the operation performed in the first sub-block SB1 is an operation causing the disturb in the remaining sub-blocks SB2, . . . , SBn, the CDC manager 111 may record or change the number of times of the corresponding operation in the CDC table 112.

In at least one embodiment, the operation causing the disturb may include the program operation and/or the erase operation. In addition, according to at least one embodiment, the operation causing the disturb may include an operation of changing data of a sub-block.

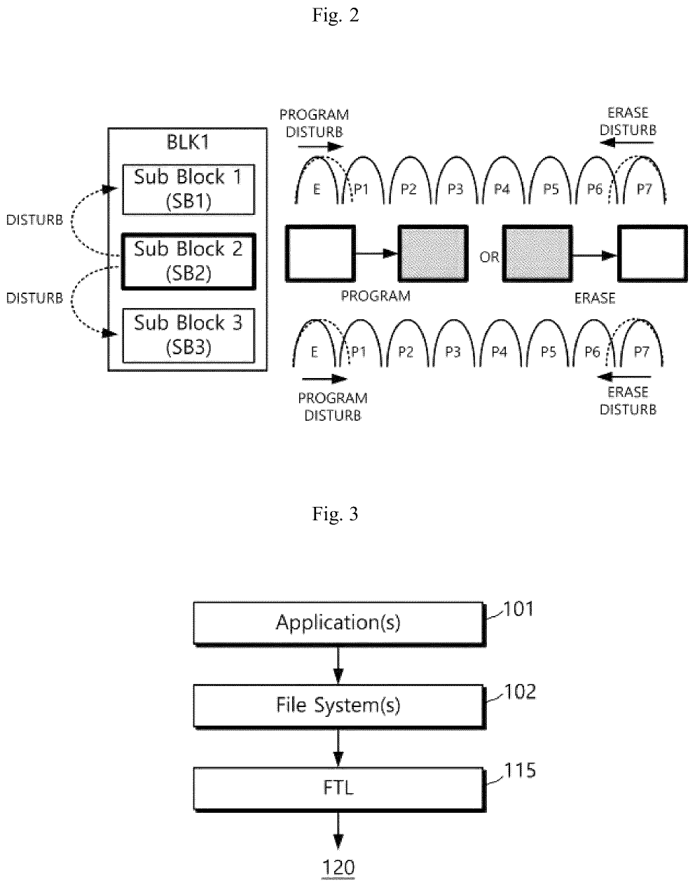

The disturb due to the program operation and the erase operation will be described with reference to FIG. 2.

Referring to FIG. 2, the first block BLK1 includes a plurality of sub-blocks (e.g., sub-blocks SB1, SB2, and SB3). The plurality of sub-blocks SB1, SB2, and SB3 may be mutually called sister sub-blocks. For example, the second sub-block SB2 and the third sub-block SB3 may be sister sub-blocks of the first sub-block SB1.

In at least one embodiment, the sister sub-blocks may mean sub-blocks included in the same block. Accordingly, the sister sub-blocks may share the same bit lines. The sub-blocks may correspond to different word lines. Accordingly, the sub-blocks may be connected to different pass transistors.

FIG. 2 shows how at least portion of data is recorded in the first sub-block SB1 and the third sub-block SB3. For example, the first sub-block SB1 of FIG. 2 may store bits based on eight different threshold voltage distributions. Also, the third sub-block SB3 may store bits based on eight different threshold voltage distributions.

In this case, when there is performed the program operation on the second sub-block SB2, the disturb may be caused in the first sub-block SB1 and the third sub-block SB3. For example, at least some of the threshold voltage distributions of the first sub-block SB1 and the third sub-block SB3 may shift to the right. For example, some of threshold voltages of distributions of the first sub-block SB1 and the third sub-block SB3, which correspond to a lower state, may increase. Also, when there is performed the erase operation on the second sub-block SB2, the disturb may be caused in the first sub-block SB1 and the third sub-block SB3. For example, at least some of the threshold voltage distributions of the first sub-block SB1 and the third sub-block SB3 may shift to the left. For example, some of threshold voltages of distributions of the first sub-block SB1 and the third sub-block SB3, which correspond to an upper state, may decrease.

Likewise, when there is performed the program operation and/or the erase operation on the first sub-block SB1, the disturb may be caused in the second sub-block SB2 and/or the third sub-block SB3 being sister sub-blocks of the first sub-block SB1.

When the disturb is continuously caused by the sister sub-block, the reliability of data stored in a sub-block in which the disturb is caused as much as a given count or more may be reduced. That is, the data stored in the corresponding sub-block may be degraded. Accordingly, the memory controller 110 may manage the number of times of the disturb caused in the sister sub-block and may reclaim (or refresh) the data of the sub-block reaching the degradation of the given reference before the data is lost and/or damaged.

FIG. 2 shows an example in which the disturb is caused in an adjacent sister sub-block, but the disturb may be caused in a sister sub-block which is not directly adjacent. For example, unlike the example illustrated in FIG. 2, when there is performed the program operation on the first sub-block SB1, the disturb may be caused in the second sub-block SB2 and the third sub-block SB3. In FIG. 2, the second sub-block SB2 may be placed adjacent to the first sub-block SB1, and the third sub-block SB3 is not placed adjacent to the first sub-block SB1. Accordingly, the memory controller 110 may manage the number of times of the disturb caused in the second sub-block SB2 and the third sub-block SB3 due to the operation of the first sub-block SB1 and may determine whether data of the second sub-block SB2 and the third sub-block SB3 are degraded.

In at least one embodiment, the operation of causing the disturb may include a read operation.

In at least one embodiment, the operation of causing the disturb may include a special operation. The special operation may include a secure erase operation and/or a dummy code program operation. A dummy code may include, e.g., a code of a preset specific pattern in addition to a code including zero bits.

In at least one embodiment, when the special operation is formed of at least one program operation and at least one erase operation, the CDC manager 111 may change the number of times of the disturb of the program operation and the number of times of the disturb of the erase operation, together with the change in the number of times of the disturb of the special operation. Alternatively, in this case, the CDC manager 111 may change the number of times of the disturb of each of the program operation and the erase operation constituting the special operation, in the CDC table 112. That is, the CDC manager 111 may manage the number of times of the disturb in various methods depending on a configuration of the CDC table 112.

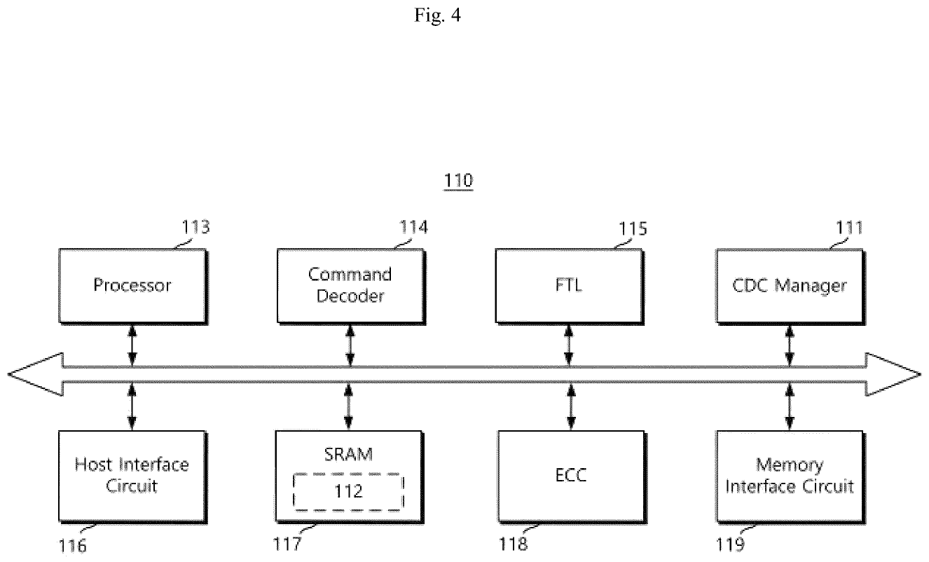

FIG. 3 is a diagram illustrating a software architecture of the storage device 100 of FIG. 1.

Referring to FIGS. 1 and 3, the software architecture of the storage device 100 may include at least some of an application 101, a file system 102, and a flash translation layer (FTL) 103. In at least one embodiment, the application 101 and the file system 102 may be included in an external device (e.g., a host) or may be driven by the external device.

The application 101 may include various programs which are driven on an operating system (OS) of the external device. For example, the application 101 may include various programs such as a text editor, an image player, and a web browser.

The file system 102 may perform a role of organizing files or data which are used by the application 101. For example, the file system 102 may provide an address of a file or data. In at least one embodiment, the address may be a logical address which is organized or managed by the external device.

The flash translation layer 115 provides an interface between the external device and the memory device 120 such that the memory device 120 is efficiently used. For example, the flash translation layer 115 may perform an operation of translating a logical address provided from the external device into a physical address usable in the memory device 120. For example, the flash translation layer 115 may manage the above address translation operation through a mapping table.

In at least one embodiment, the CDC manager 111 described with reference to FIG. 1 may use the flash translation layer 115. The CDC manager 111 may check a sister sub-block of a sub-block in which an operation causing the disturb is performed, through the flash translation layer 115.

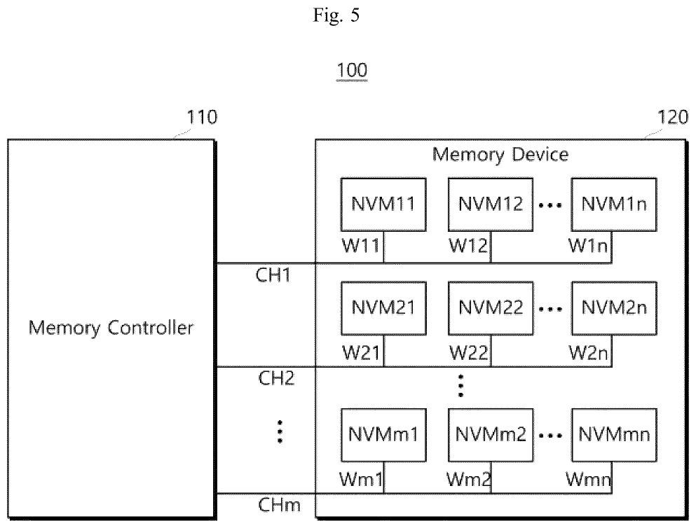

FIG. 4 is a block diagram describing at least one embodiment of the memory controller 110 of FIG. 1.

The memory controller 110 may include a processor 113, a command decoder 114, the flash translation layer 115, the CDC manager 111, a host interface circuit 116, an SRAM 117, an error correction code (ECC) circuit 118, and a memory interface circuit 119. Although not illustrated in FIG. 4, the memory controller 110 may include a packet manager and/or a working memory device.

The processor 113 is configured to be implemented with a circuit, logic, a code, and/or a combination thereof. The processor 113 overall controls operations of the storage device 100 including the memory controller 110. When the storage device 100 is driven, the processor 113 may load the firmware stored in a read only memory (ROM) to the working memory device and may perform all the operations of the memory controller 110. The processor 113 may load the flash translation layer 115 to the working memory device; based on an address translation result of the flash translation layer 115, the processor 113 may program data in the memory device 120 and/or may read data from the memory device 120. In the specification, the terms “read” and “readout” are used as having the same (or substantially similar) meaning.

The memory controller 110 is configured to communicate with the host through the host interface circuit 116. The host interface circuit 116 may be implemented with various interface manners such as advanced technology attachment (ATA), serial ATA (SATA), external SATA (e-SATA), small computer small interface (SCSI), serial attached SCSI (SAS), peripheral component interconnection (PCI), PCI express (PCIe), IEEE 1394, universal serial bus (USB), NVMe, CXL, any combination thereof, and/or the like.

The command decoder 114 is configured to decode a command parsed from the command, based on a protocol of an interface negotiated on the host. The packet manager may parse the command from the packet received from the host, based on the protocol of the interface negotiated on the host. For example, the command decoder 114 may decode an opcode of the command which is based on a specific protocol and may identify a program command, an erase command, a read command, and/or a secure erase command. The processor 113 may perform the request of the host depending on the decoded command. In at least one embodiment, the command decoder 114 may be implemented as a portion of an independent circuit and/or firmware.

The flash translation layer 115 is configured to perform various functions (or operations) such as address mapping, wear-leveling, garbage collection, any combination thereof, and/or the like.

The address mapping operation refers to an operation of translating a logical address received from the host into a physical address to be used to actually program data in memory device 120. For example, a logical block address (LBA) of user data which are requested by the host to be programmed may be translated into a physical address of the memory device 120 by using the flash translation layer 115. In at least one embodiment, the physical address may be a physical page number (PPN). In at least one embodiment, an address mapping table which the flash translation layer 115 manages may store a mapping relationship between a logical page number (LPN) and a physical page number. In at least one embodiment, each of logical page numbers LPN may correspond to a plurality of logical block addresses LBA.

In at least one embodiment, the logical page number LPN may correspond to a physical address of a sub-block of the memory device 120 according to at least one embodiment of the present disclosure.

The wear-leveling, which is a technology for allowing blocks of the memory device 120 to be used uniformly such that excessive degradation of a specific block is reduced and/or prevented, may be implemented, for example, through a firmware technology for balancing erase counts of physical blocks. The garbage collection refers to a technology for securing an available capacity of the memory device 120 through a way to copy valid data of a block to a new block and to then erase the block.

In at least one embodiment, when the degradation of a sub-block is checked, the memory controller 110 according to at least one embodiment of the present disclosure may reclaim data of the sub-block and/or may perform wear-leveling.

The working memory device (not illustrated) may include registers for storing variables in the memory controller 110. In at least one embodiment, the working memory device may operate as a buffer memory and may temporarily store data to be recorded at the memory device 120 and/or data read from the memory device 120. The working memory device may be implemented with a volatile memory device. According to at least one embodiment, the working memory device may be disposed inside and/or outside the memory controller 110. Alternatively, when the host buffer memory is provided by the host, the working memory device may be included and/or may not operate as a buffer memory.

The ECC circuit 118 is configured to generate parity information by performing ECC encoding on data to be programmed in the memory device 120 and may add the parity information to the data. Also, the ECC circuit 118 may detect an error bit from the data read from the memory device 120. For example, the memory controller 110 may detect an error bit by performing ECC decoding on the read data. FIG. 4 shows the case where the memory controller 110 includes the ECC circuit 118, but the present disclosure is not limited thereto. For example, the memory device 120 may include an on-die ECC circuit.

According to at least one embodiment of the present disclosure, when a command requested from the host is set in advance as causing the disturb, the CDC manager 111 may change the CDC table 112 to correspond to the decoding of the command. For example, a program command, an erase command, and a read command may be stored in advance in a command table as a command causing the disturb. When the decoded command is one of the program command, the erase command, and the read command, the CDC manager 111 may change the CDC table 112. In at least one embodiment, the CDC manager 111 may be implemented as a portion of an independent circuit and/or firmware.

The CDC manager 111 may change the CDC table 112 even in association with a command generated by an internal operation, in addition to the command requested from the host. For example, to perform the wear-leveling and/or the garbage collection, the CDC manager 111 may internally generate an internal program command for the program operation of the sub-block and/or an internal erase command for the erase operation of the sub-block. The CDC manager 111 may change an entry of the CDC table 112, which corresponds to a sub-block where an operation corresponding to the internal command is performed.

In at least one embodiment, when the decoded command and/or the internal command corresponds to a plurality of operations, the CDC manager 111 may change entries of the CDC table 112, which respectively correspond to the plurality of operations. For example, when the specific command indicates data erasing and programming on the sub-block, the CDC manager 111 may change an erase count entry and a program count entry associated with the corresponding sub-block (or a sister sub-block of the corresponding sub-block) in the CDC table 112.

In at least one embodiment, when the decoded command corresponds to the special operation, the CDC manager 111 may additionally change a special operation count entry in the CDC table 112. The special operation may include the secure erase operation and/or the dummy code program operation.

For example, a command corresponding to the secure erase operation may include a sanitize command of the NVMe, a purse command for a replay protection memory block (RPMB) area of the UFS 4.0 and a secure erase command based on various kinds of protocols.

In at least one embodiment, the dummy code program operation may be performed by the internal command of the storage device 100. For example, according to at least one embodiment, in the flush command of the NVMe, the dummy code program operation based on the policy of the storage device 100 may be performed in addition to the operation of programming cache data of a buffer in the memory device 120. In these cases, the CDC manager 111 may change the program count entry of the CDC table 112 together with the dummy code program count entry of the CDC table 112.

The CDC table 112 may be stored in the SRAM 117 or may be stored in the working memory device. For example, the CDC table 112 may be stored in a given area of the memory device 120; after the storage device 100 is driven, the CDC table 112 may be read from the memory device 120 and may then be stored in the SRAM 117 or the working memory device.

In at least one embodiment, the CDC manager 111 is configured to change the CDC table 112 in consideration of a distance of a sister sub-block from a sub-block where an operation is performed. For example, when a first sub-block, a second sub-block, and a third sub-block are disposed adjacent to each other in the order, the CDC manager 111 may change the program count entries associated with the second sub-block and the third sub-block, based on the program operation performed in the first sub-block. In this case, the CDC manager 111 may change the CDC table 112 such that a change in a value of the program count entry associated with the second sub-block is greater than a change in a value of the program count entry associated with the third sub-block.

When disturbs of a sub-block recorded at the CDC table 112 satisfy the preset reference condition (or preset reference), the processor 113 may read data of the sub-block in which the reference is satisfied and may detect an error bit of the read data by using the ECC circuit 118.

In at least one embodiment, when one of entries recorded at the CDC table 112 reaches a preset threshold value, the processor 113 may determine that the disturbs satisfy the preset reference. For example, the CDC table 112 may include a program count entry corresponding to the number of times of the program operation, an erase count entry corresponding to the number of times of the erase operation, and a special operation count entry corresponding to the number of times of the special operation. When a value of one of the program count entry, the erase count entry, and the special operation count entry reaches the threshold value, the processor 113 may determine that the preset reference is satisfied and may check the degradation of the sub-block.

In at least one embodiment, the processor 113 is configured to determine whether the disturbs satisfy the preset reference, in consideration of all the entries recorded at the CDC table 112. For example, the processor 113 may apply different weights to the program count entry, the erase count entry, and the special operation count entry, respectively, and may compare the preset threshold value and a result of summing values of the entries to which the weights are applied or a result of applying a separate equation to the values. The equation may be experimentally determined. In at least one embodiment, the weight of the program count entry corresponding to the number of times of the program operation and the weight of the erase count entry corresponding to the number of times of the erase operation may be set to be higher than the weight of the read count entry corresponding to the number of times of the read operation. In at least one embodiment, the weight of the special operation count entry corresponding to the number of times of the special operation may be set to be higher than the weight of the program count entry and the weight of the erase count entry. The special operation count entry may be determined differently for each special operation. The weight may be set differently for each special operation.

The processor 113 may read data of a sub-block in which the preset reference is satisfied and may detect an error bit of the read data using the ECC circuit 118. When a ratio of detected error bits exceeds a given reference, the processor 113 may determine that a reference condition has been met and may reclaim data of a sub-block and/or may perform the wear-leveling. An operation of reading data of a sub-block may be defensively performed to determine whether the sub-block is degraded, not by the request of the host.

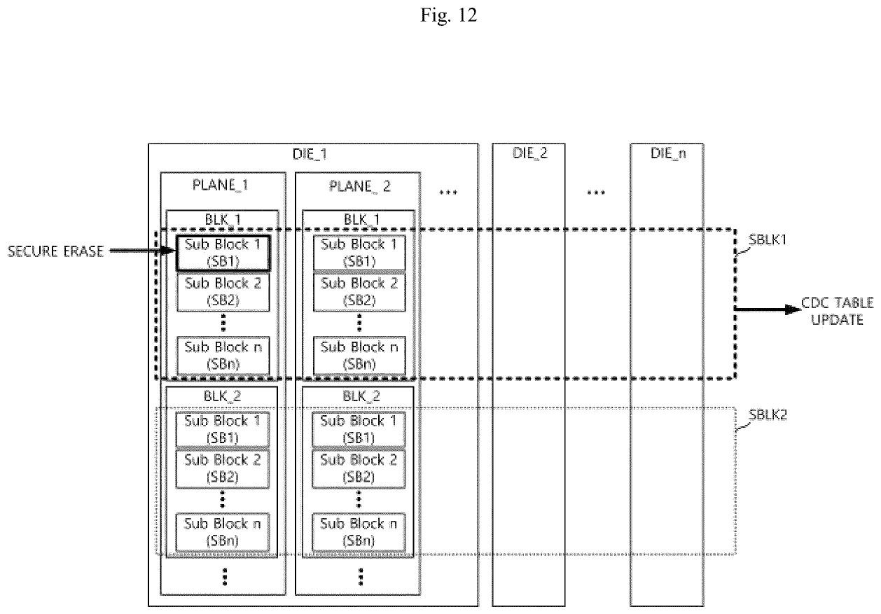

The sub-block in which the preset reference is satisfied may be a sister sub-block of a sub-block in which data are changed and/or a block different from a sub-block in which data are changed. Below, the description will be given with reference to FIGS. 11 to 19. A sub-block in which the preset reference is satisfied, that is, a sub-block which is determined as being degraded may also be referred to as a “target sub-block.”

In at least one embodiment, based on a result of comparing the program count entry of the CDC table 112 and a first threshold value determined in advance, the processor 113 may perform the read operation on a least significant bit (LSB) page of the target sub-block. Based on a result of comparing the erase count entry of the CDC table 112 and a second threshold value determined in advance, the processor 113 may perform the read operation on a most significant bit (MSB) page of the target sub-block.

For example, as described with reference to FIG. 2, when the program operation is performed in any sub-block in duplicate, some of threshold voltages of a distribution of a sister sub-block, which correspond to a lower state, may increase. Accordingly, to determine whether data degradation is made due to the change in some of the threshold voltages of the sister sub-block corresponding to the lower state, the processor 113 may perform the read operation on the LSB page of the target sub-block.

Likewise, the erase operation may be performed in any sub-block in duplicate; in this case, to determine whether data degradation is made due to the change in some of threshold voltages of a distribution of a sister sub-block, which correspond to the upper state, the processor 113 may perform the read operation on the MSB page of the target sub-block.

In at least one embodiment, the processor 113 may determine whether a first condition is achieved, based on entries of the CDC table 112; when the first condition is achieved, the processor 113 may perform the read operation on the LSB page of the target sub-block. The processor 113 may determine whether a second condition is achieved, based on entries of the CDC table 112; when the second condition is achieved, the processor 113 may perform the read operation on the MSB page of the target sub-block. The first condition and the second condition may satisfy values of at least some of entries with at least one threshold value. Alternatively, the first condition and the second condition may compare a value calculated based on values of at least some of entries with the threshold value. For example, when a value of the program count entry reaches the first threshold value set in advance and a value of the special operation count entry reaches the second threshold value set in advance, the processor 113 may perform the read operation on the LSB page of the target sub-block. The first condition and the second condition may vary depending on the change in the configuration of the memory device 120.

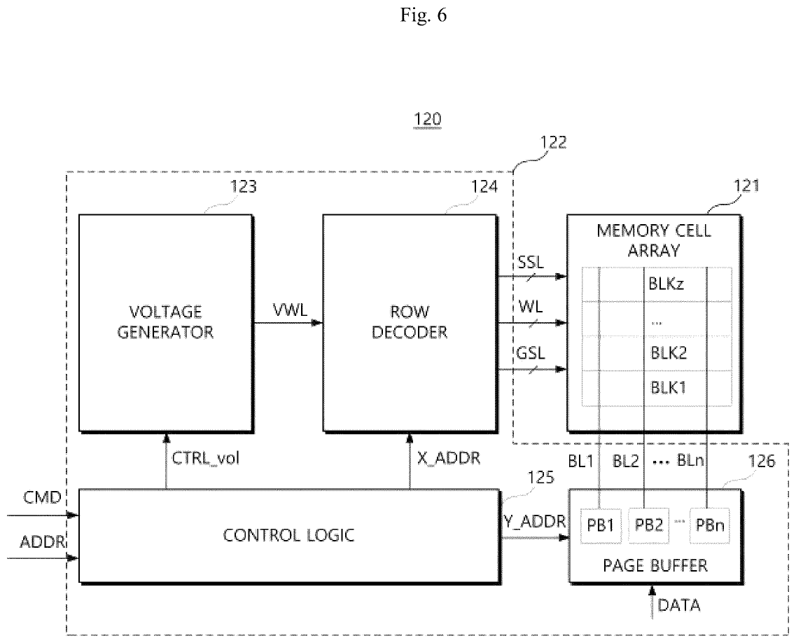

FIG. 5 is a diagram describing a configuration according to at least one embodiment of the memory device 120 of FIG. 1.

The memory controller 110 may perform an I/O on a plurality of memory devices NVM11 to NVMmn through a plurality of channels CHi to CHm. The memory device 120 and the memory controller 110 may be connected through the plurality of channels CHi to CHm. In at least one embodiment, the memory controller 110 may include a plurality of controller modules respectively corresponding to the plurality of channels CHi to CHm.

The memory controller 110 may control a memory device (e.g., one of NVM11 to NVMmn) connected to one of the plurality of channels CHi to CHm through a way.

The memory controller 110 may exchange signals with the memory device 120 through the plurality of channels CHi to CHm.

The memory device 120 may include the plurality of nonvolatile memory devices NVM11 to NVMmn. Each of the nonvolatile memory devices NVM11 to NVMmn may be a nonvolatile memory package. In at least one embodiment, each of the nonvolatile memory devices NVM11 to NVMmn may include a plurality of dies, but the present disclosure is not limited thereto.

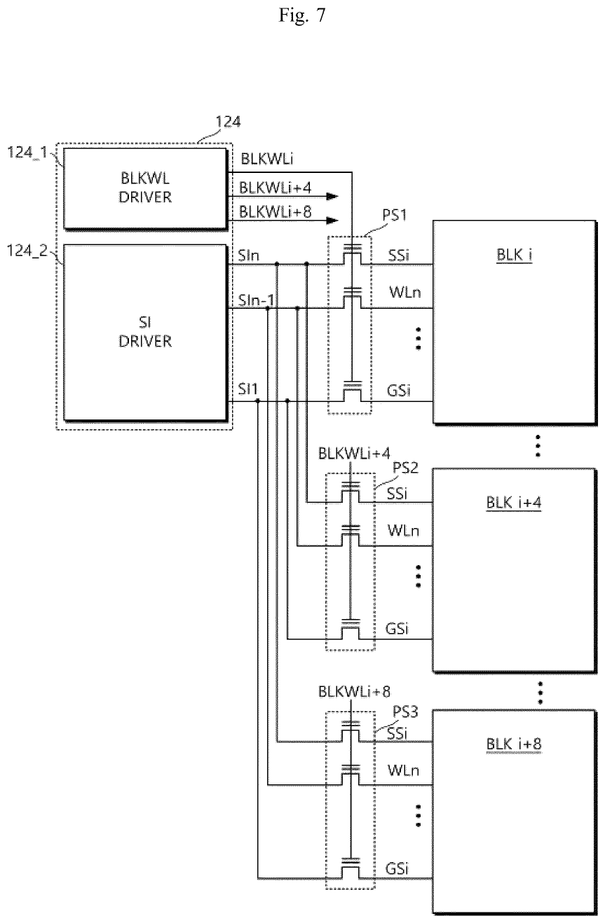

FIG. 6 is a diagram illustrating a configuration of the memory device 120 of FIG. 1.

Referring to FIG. 6, the memory device 120 may include the memory cell array 121 and a peripheral circuit 122, and the peripheral circuit 122 may include a control logic circuit 125, a page buffer 126, a voltage generator 123, and a row decoder 124.

The control logic circuit 125 may overall control various kinds of operations of the memory device 120. The control logic circuit 125 may output various kinds of control signals in response to a command CMD and/or a physical address ADDR from the memory interface circuit 119 (refer to FIG. 4). For example, the control signals may include a voltage control signal CTRL_vol, a row address X_ADDR, and a column address Y_ADDR.

The memory cell array 121 may include a plurality of memory blocks BLK1 to BLKz (z being a positive integer), and each of the plurality of memory blocks BLK1 to BLKz may include a plurality of memory cells. The memory blocks BLK1 to BLKz may be connected to the page buffer 126 through bit lines BL1 to BLn and may be connected to the row decoder 124 through word lines WL, string select lines SSL, and ground select lines GSL.

The page buffer 126 may include a plurality of page buffers PB1 to PBn (n being an integer of 3 or more), and the plurality of page buffers PB1 to PBn may be respectively connected to memory cells included in each of the plurality of memory blocks BLK1 to BLKz through the plurality of bit lines BL1 to BLn. The page buffer 126 may select at least one of the bit line BL1 to BLn in response to the column address Y_ADDR. The page buffer 126 may operate as a write driver or a sense amplifier depending on an operation mode. For example, in the program operation, the page buffer 230 may apply a bit line voltage corresponding to data to be programmed to the selected bit line. In the read operation, the page buffer 126 may sense a current or a voltage of the selected bit line to read data stored in a memory cell.

The voltage generator 123 is configured to generate various kinds of voltages for performing the program operation, read operation, and the erase operation, etc. based on the voltage control signal CTRL_vol.

In response to the row address X_ADDR, the row decoder 124 may select one of the plurality of word lines WL and may select one of the plurality of string select lines SSL.

Each of the plurality of memory blocks BLK1 to BLKz according to at least one embodiment of the present disclosure may include a plurality of sub-blocks. The row decoder 124 may select a sub-block targeted for the erase operation.

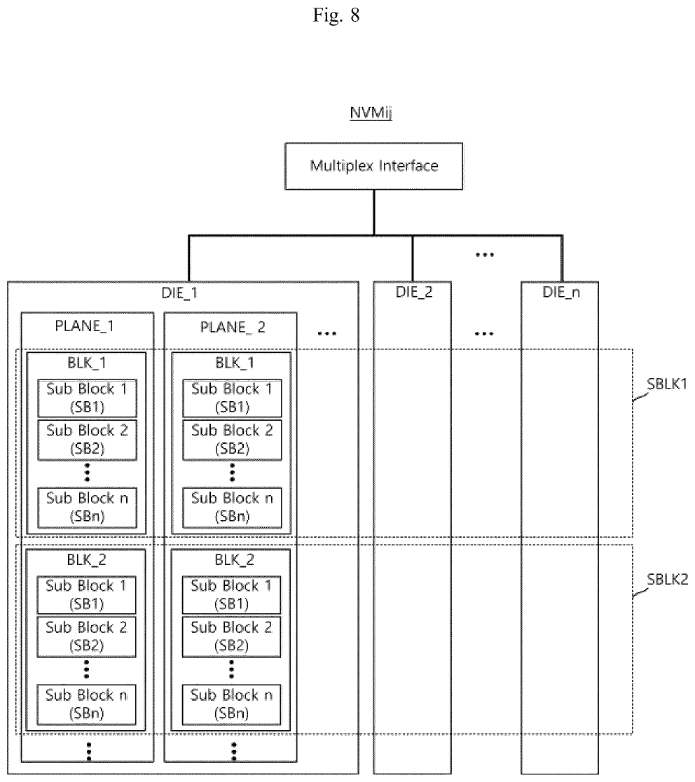

FIG. 7 is a diagram illustrating at least one embodiment of a configuration of the row decoder 124 of the memory device 120 of FIG. 6.

Referring to FIG. 7, the row decoder 124 may include a block word line driver 124_1 and an SI driver 1242.

The SI driver 124_2 is configured to provide voltages provided from the voltage generator 123 of FIG. 6 to memory blocks BLK i, BLK i+4, and BLK i+8 through a plurality of pass switch circuits PS1, PS2, and PS3 in response to a block address. In at least one embodiment, one SI driver may provide word line voltages to a plurality of memory blocks through a plurality of pass switch circuits.

For example, referring to FIG. 7, voltages SIl, . . . , SIn-1, and SIn which the SI driver 1242 provides may be provided to the plurality of pass switch circuits PS1, PS2, and PS3 and may be provided to the word lines of the plurality of the memory blocks BLK i, BLK i+4, and BLK i+8 through the plurality of pass switch circuits PS1, PS2, and PS3 controlled by block selection signals BLKWLi, BLKWLi+4, and BLKWLi+8. That is, the plurality of memory blocks BLK i, BLK i+4, and BLK i+8 share a voltage to be provided to a word line.

FIG. 7 shows an example in which one SI driver 124_2 provides word line voltages to three memory blocks BLK i, BLK i+4, and BLK i+8, but the number of memory blocks to which an SI driver provides word line voltages may be different from that of the above example.

The SI driver 124_2 may also be configured to provide a string selection voltage SSi and a ground selection voltage GSi to the plurality of memory blocks BLK i, BLK i+4, and BLK i+8, in addition to the word line voltages WLn.

A memory controller (e.g., the memory controller 110 of FIG. 1) according to at least one embodiment of the present disclosure may change a CDC table of a block, which shares a voltage provided to a word line of a sub-block where an operation is performed, based on the operation performed in the sub-block. When values of entries (of the CDC table) corresponding to the block whose CDC table is changed satisfy the preset reference, the memory controller 110 may determine whether the block is degraded.

This will be described with reference to FIG. 7. When an operation performed in a sub-block of a first memory block (e.g., BLK i) among the plurality of memory blocks BLK i, BLK i+4, and BLK i+8 sharing a voltage provided to a word line is an operation causing the disturb, the memory controller 110 may change entries of the CDC table corresponding to the remaining memory blocks (e.g., BLK i+4 and BLK i+8) sharing the voltage provided to the word line. When values of entries of a CDC table satisfy the preset reference, the memory controller 110 may determine whether the block memory is degraded.

When a plurality of memory blocks share a voltage to be provided to a word line, the voltage to be provided to the word line for an operation of a memory block may be substantially prevented (and/or reduced) from being provided to the remaining memory block(s) by a pass switch circuit. However, even though the pass switch circuit is provided, the probability that another memory block experiences the disturb due to the voltage provided to the word line exits. Accordingly, as the disturbs of not only a sister sub-block but also any other memory blocks sharing the voltage provided to the word line are managed by using the CDC table, the reduction of performance of the other memory blocks may be reduced and/or prevented in advance.

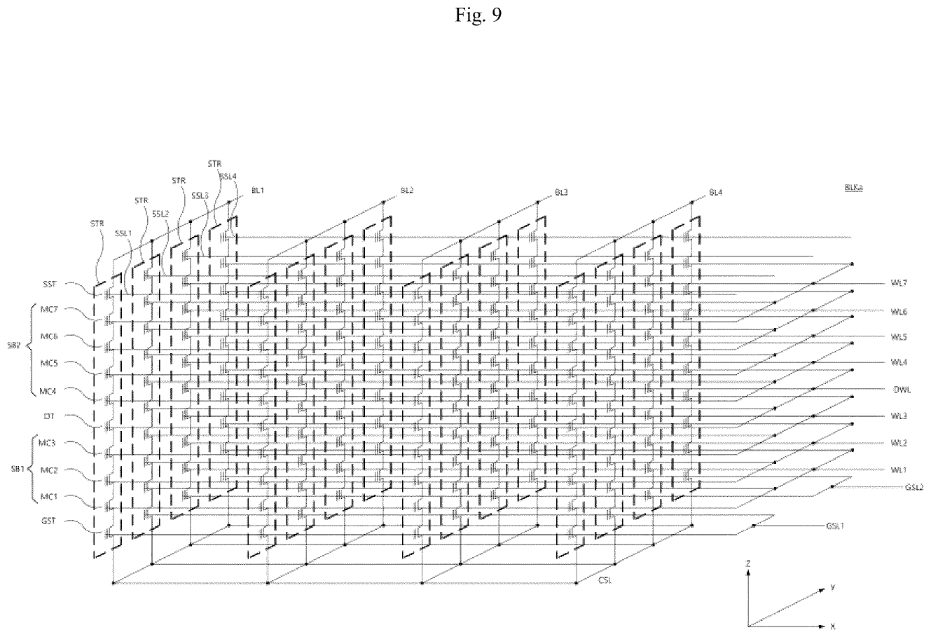

FIG. 8 is a diagram describing a configuration of memory blocks according to at least one embodiment of the memory device 120 of FIG. 1.

The nonvolatile memory device NVMij of FIG. 8 may correspond to one of the nonvolatile memory devices NVM11 to NVMmn of FIG. 5.

The nonvolatile memory device NVMij may include a plurality of dies DIE_1 to DIE_n, and each of the plurality of dies DIE_1 to DIE_n may include a plurality of planes (e.g., PLANE_1, PLANE_2, etc.). Each plane may include a plurality of memory blocks BLK_1, BLK_2, etc.

In at least one embodiment, the plurality of memory blocks BLK_1, BLK_2, etc. included in the plurality of dies DIE_1 to DIE_n may be grouped into super blocks SBLK1, SBLK2, etc. For example, the plurality of memory blocks BLK_1 respectively included in the plurality of dies DIE_1 to DIE_n may be grouped as the first super block SBLK1, and the plurality of memory blocks BLK_2 respectively included in the plurality of dies DIE_1 to DIE_n may be grouped as the second super block SBLK2.

According to at least one embodiment, the memory block BLK may be a physical block. The super block SBLK may refer to a unit of a logical memory area, which is used for the memory controller 110 to manage the memory device 120.

Each of the memory blocks BLK_1, BLK_2, etc. according to at least one embodiment of the present disclosure may include the plurality of sub-blocks SB1, SB2, . . . , SBn. In at least one embodiment, the plurality of sub-blocks SB1, SB2, . . . , SBn included in the plurality of memory blocks BLK_1, BLK_2, etc. may be grouped into super sub-blocks (not illustrated).

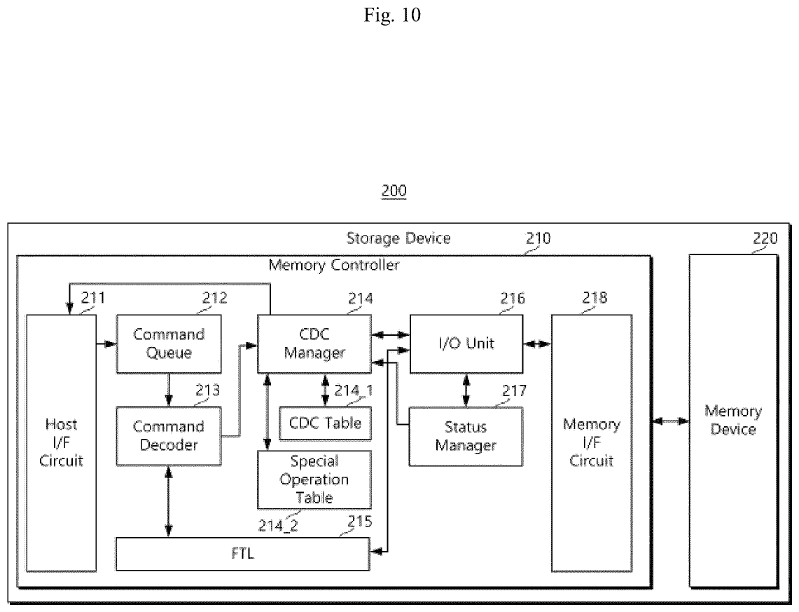

FIG. 9 is a diagram illustrating memory cells constituting a memory block according to at least one embodiment of the memory device 120 of FIG. 1. FIG. 9 is a diagram illustrating at least one embodiment of a memory block of a three-dimensional V-NAND structure in detail. In FIG. 9, the memory block BLKa according to at least one embodiment may correspond to one of the memory blocks BLK_1, BLK_2, etc. of FIG. 8. When a nonvolatile memory of the memory device 120 is implemented with a flash memory of a 3D V-NAND type, each of a plurality of memory blocks constituting the nonvolatile memory may be expressed by an equivalent circuit illustrated in FIG. 9. When a nonvolatile memory of the memory device 120 is implemented with a flash memory of a 3D V-NAND type, the present disclosure may be implemented with another equivalent circuit without limitation to the equivalent circuit illustrated in FIG. 9.

Referring to FIG. 9, a plurality of strings STR may be arranged on a substrate in rows and columns. The plurality of strings STR may be connected in common to a common source line CSL formed on (or in) the substrate.

A common source line CSL is electrically connected to the lower ends of the strings STR For example, the common source line CSL may be connected to lower ends of the strings STR as illustrated in FIG. 9. However, the present disclosure is not limited to the case that the common source line CSL is physically located at the lower ends of the strings STR. An example is illustrated in FIG. 9 as the strings STR are arranged in a four-by-four matrix. However, the number of strings in the memory block BLKa may increase or decrease.

The strings STR in each row may be connected in common to a ground select line GSL1 or GSL2. For example, the strings STR in first and second rows may be connected in common to the first ground select line GSL1, and strings STR in third and fourth rows may be connected in common to the second ground select line GSL2. However, this is provided as an example. For example, four different ground select lines may be provided, and the strings STR in the first to fourth rows may be implemented to be connected to the four different ground select lines.

The strings STR in each row may be connected to a corresponding string select line among first to fourth string select lines SSL1 to SSL4. The strings STR in each column may be connected to a corresponding bit line among first to fourth bit lines BL1 to BL4.

Each string STR may include at least one ground selection transistor GST connected to the ground select line GSL1 or GSL2, a plurality of memory cells MC1 to MC7 respectively connected to a plurality of word lines WL1 to WL7, and a string selection transistor SST connected to the string select line SSL1, SSL2, SSL3, or SSL4. Also, each string STR may include a dummy transistor DT connected to a dummy word line DWL.

Sub-blocks may be separated from each other in any other methods except for a method of using the dummy transistor DT illustrated in FIG. 9, and a method of separating sub-blocks is not particularly limited.

In each string STR, the ground selection transistor GST, the memory cells MCi to MC7, the dummy transistor DT, and the string selection transistor SST may be connected in series along a direction perpendicular to the substrate and may be sequentially stacked along the direction perpendicular to the substrate.

The dummy transistor DT according to at least one embodiment of the present disclosure may be disposed at various locations.

In at least one embodiment, the dummy transistor DT may be disposed at a location where the size of the first sub-block SB1 is defined to be smaller than the size of the second sub-block SB2. Alternatively, in at least one embodiment, the dummy transistor DT may be disposed at a location where the size of the first sub-block SB1 is defined to be larger than the size of the second sub-block SB2.

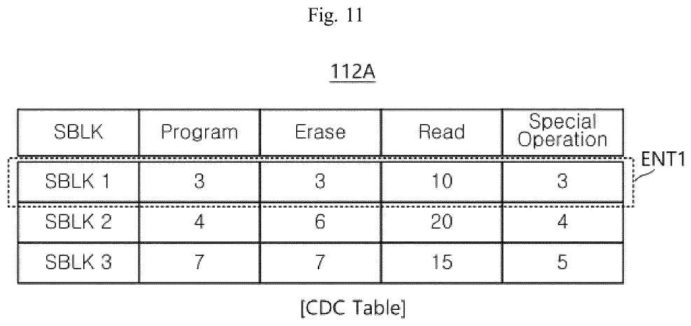

FIG. 10 is a block diagram describing at least one embodiment of the memory controller 110 of FIG. 1. A memory controller 210 will be described with reference to FIG. 10. Additional description associated with components the same as or substantially similar to the components described with reference to FIG. 4 will be omitted to avoid redundancy.

Referring to FIG. 10, the memory controller 210 may receive a request through a host interface circuit 211, based on a protocol of an interface negotiated on a host. The request may be in the form of a packet.

A command queue 212 is configured to store the request received through the host interface circuit 211.

A command decoder 213 is configured to decode a command parsed from the command, based on the protocol of the interface negotiated on the host.

When the parsed command is set in advance as causing the disturb, the command decoder 213 according to at least one embodiment may provide information about the command to a CDC manager 214. For example, the command decoder 213 may provide identification information of a command set in advance for each command and an address targeted for the command. The address may be a physical address translated by the command decoder 213 through a flash translation layer 215. In at least one embodiment, the physical address may include a number of a block and/or a number of a sub-block.

The CDC manager 214 is configured to change a CDC table 2141, based on the identification information of the command and the address provided from the command decoder 213. That is, the CDC manager 214 may change an entry associated with a sub-block corresponding to the address and/or a sister sub-block of the sub-block corresponding to the address.

The CDC manager 214 may check a special operation table 214_2 to determine whether the identification information of the command corresponds to the special operation. Alternatively, the CDC manager 214 may check unit operations (e.g., the program operation, the erase operation, and/or the read operation) for performing the special operation by using the special operation table 214_2. When the identification information of the command corresponds to the special operation, the CDC manager 214 may additionally change an entry corresponding to the special operation from among entries of the CDC table 214_1.

The CDC manager 214 may transfer the address and the identification information of the command to an input/output (I/O) unit 216, and the input/output unit 216 may drive a memory device 220 through a memory interface circuit 218.

A status manager 217 may internally generate a command regardless of the request transmitted from the host. The CDC manager 214 may change the CDC table 214_1, based on the internal command.

For example, when an internal condition is satisfied, to perform the wear-leveling and/or the garbage collection, the status manager 217 may internally generate the internal program command for the program operation of the sub-block and/or the internal erase command for the erase operation of the sub-block. The CDC manager 214 may change an entry of the CDC table 2141, which corresponds to a sub-block where an operation corresponding to the internal command is performed. The generation of the internal command is not limited to the execution of the wear-leveling and/or the garbage collection, and various internal commands may be generated based on various policies and a configuration of a storage device.

The embodiment described with reference to FIG. 10 is provided as an example, and the present disclosure may be implemented through various embodiments different from the embodiment of FIG. 10. For example, the command decoder 213 may provide a command and an address to the input/output unit 216, and the input/output unit 216 may complete the operation of the memory device 220 corresponding to the command and may then provide the CDC manager 214 with the command and address corresponding to the completed operation.

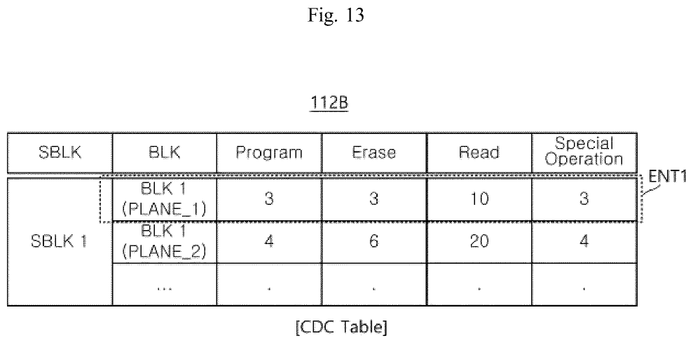

FIG. 11 is a diagram illustrating a configuration according to at least one embodiment of a CDC table. FIG. 12 is a diagram describing an example of changing a CDC table based on a CDC table of FIG. 11. The CDC table 112A of FIG. 11 is an example corresponding to the CDC table of the embodiments described with reference to FIGS. 1 to 10. FIG. 11 will be described based on three super blocks SBLK 1, SBLK 2, and SBLK 3. Each of the super blocks SBLK 1, SBLK 2, and SBLK 3 may include a plurality of blocks, and each of the plurality of blocks may include a plurality of sub-blocks. At least one embodiment of the present disclosure will be described with reference to FIGS. 11 and 12.

Referring to FIG. 11, the CDC manager may be configured to manage the CDC table 112A in units of super block. FIG. 11 is illustrated as an example wherein operations which cause the disturb include the program operation, the erase operation, the read operation, the special operation, and/or any combination thereof; but the present disclosure is not limited thereto.

In the case of performing an operation on any sub-block, the CDC manager may change an entry associated with a super block in which the sub-block where the operation is performed is included. When the sub-block in which the operation is performed is included in the first super block SBLK 1, the CDC manager may change a value corresponding to the performed operation in an entry ENT1 associated with the super block SBLK 1.

For example, referring to FIG. 12, the first sub-block SB1 of a first block BLK_1 of a first plane PLANE_1 is included in the first super block SBLK 1. Accordingly, when the secure erase operation is performed in the first sub-block SB1 of the first block BLK_1 of the first plane PLANE_1, the CDC manager may change a value corresponding to the special operation in the entry ENT1 of the CDC table, which corresponds to the first super block SBLK 1.

When values of the entry ENT1 satisfy a preset reference, as discussed above, a memory controller may determine that data of the first super block SBLK 1 are degraded. In at least one some embodiments, a determination that the data of the first super block SBLK 1 are degraded may initiate a detection of a ratio of detected error bits and a wear-leveling may be initiated based on a determination that the ratio exceeds a reference. In at least some embodiments, a wear-leveling of the first super block SBLK 1 may be initiated based on the determination that the data are degraded.

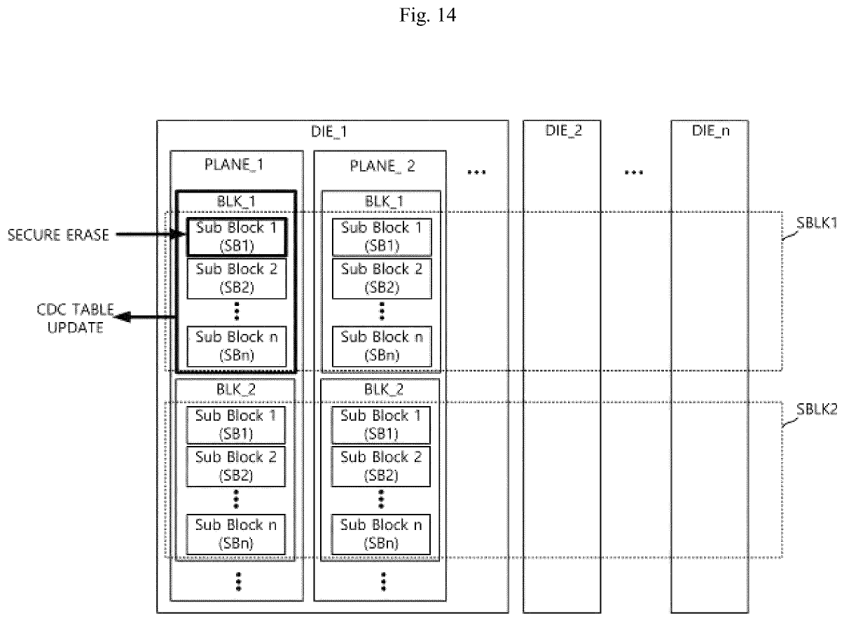

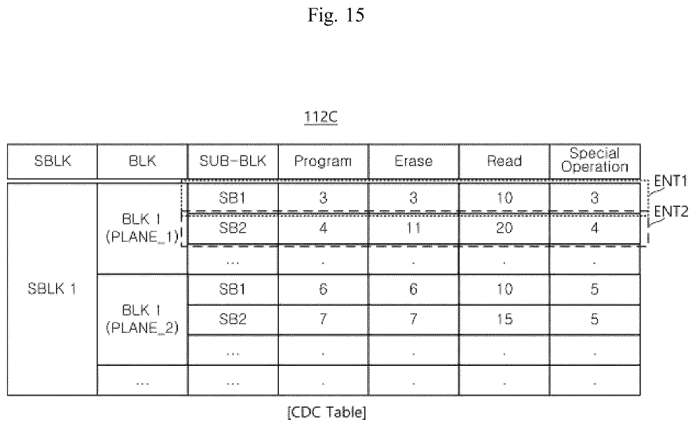

FIG. 13 is a diagram illustrating a configuration according to at least one embodiment of a CDC table. FIG. 14 is a diagram describing an example of changing a CDC table based on a CDC table of FIG. 13. A CDC table 112B of FIG. 13 may correspond to an example of the CDC table of the embodiments described with reference to FIGS. 1 to 10. In at least one embodiment, the super block SBLK 1 includes three blocks BLK_1, BLK_2, and BLK_3, however this is only an example, an the super block SBLK 1 may include more or less blocks. Each of the blocks BLK_1, BLK_2, and BLK_3 may include a plurality of sub-blocks. At least one embodiment of the present disclosure will be described with reference to FIGS. 13 and 14.

Referring to FIG. 13, the CDC manager may be configured to manage a CDC table 112B in units of block. FIG. 13 is illustrated as an example wherein operations which cause the disturb include the program operation, the erase operation, the read operation, the special operation, and/or any combination thereof; but the present disclosure is not limited thereto.

In at least one embodiment, in the case of performing an operation on a sub-block, the CDC manager may be configured to change an entry associated with a block in which the sub-block where the operation is performed is included. When the sub-block in which the operation is performed is included in the block BLK_1, the CDC manager may change a value corresponding to the performed operation in an entry ENT1 associated with the block BLK 1.

For example, referring to FIG. 14, the first sub-block SB1 of the first block BLK_1 of the first plane PLANE_1 is included in the first block BLK_1 of the first super block SBLK1. Accordingly, when the secure erase operation is performed in the first sub-block SB1 of the first block BLK_1 of the first plane PLANE_1, the CDC manager may change a value corresponding to the special operation in the entry ENT1 of the CDC table, which corresponds to the first block BLK_1 of the first plane PLANE_1 of the first super block SBLK1.

When values of the entry ENT1 satisfy the preset reference, the memory controller may determine that data of the first block BLK_1 of the first plane PLANE_1 are degraded. In at least one some embodiments, a determination that the data of the first block BLK 1 are degraded may initiate a detection of a ratio of detected error bits and a wear-leveling may be initiated based on a determination that the ratio exceeds a reference. In at least some embodiments, a wear-leveling of the first block BLK 1 may be initiated based on the determination that the data are degraded.

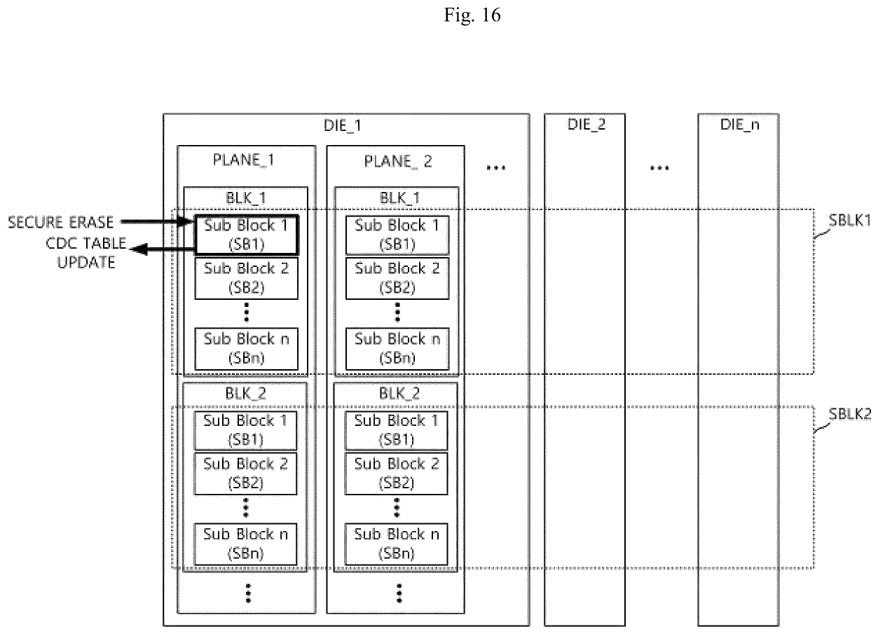

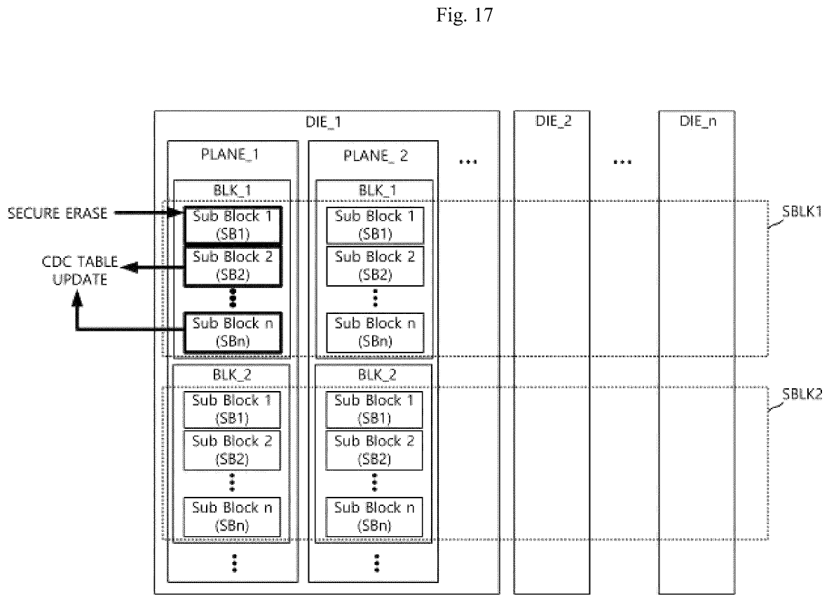

FIG. 15 is a diagram describing a configuration according to at least one embodiment of a CDC table. FIGS. 16 and 17 are diagrams describing an example of changing a CDC table based on the CDC table of FIG. 15. The CDC table 112C of FIG. 15 may correspond to an example of the CDC table of the embodiments described with reference to FIGS. 1 to 10. At least one embodiment of the present disclosure will be described with reference to FIGS. 15, 16, and 17.

Referring to FIG. 15, the CDC manager may manage a CDC table 112C in units of sub-block. FIG. 15 is illustrated as an example in which operations which cause the disturb includes the program operation, the erase operation, the read operation, the special operation, and/or any combination thereof; but the present disclosure is not limited thereto.

In at least one embodiment, in the case of performing an operation on any sub-block, the CDC manager may change an entry associated with the sub-block where the operation is performed. For example, the CDC manager may change a value corresponding to the performed operation in the entry ENT1 associated with the sub-block SB1 where the operation is performed. That is, the CDC manager may change an entry associated with a sub-block corresponding to an aggressor in the CDC table 112C.

For example, referring to FIG. 16, when the secure erase operation is performed in the first sub-block SB1 of the first block BLK_1 of the first plane PLANE_1, the CDC manager may change a value corresponding to the special operation in the entry ENT1 of the CDC table, which corresponds to the first sub-block SB1 of the first block BLK_1 of the first plane PLANE_1 of the first super block SBLK1.

In this case, when values of the entry ENT1 satisfy a preset reference, the memory controller may determine that data of the sister block SB2 of the first sub-block SB1 of the first block BLK_1 of the first plane PLANE_1 are degraded. Alternatively, the memory controller may determine that there are degraded data of the first block BLK_1 in which the first sub-block SB1 of the first block BLK_1 of the first plane PLANE_1 is included. In at least one some embodiments, a determination that the data of the first block BLK_1 of the first plane PLANE_1 are degraded may initiate a detection of a ratio of detected error bits and a wear-leveling may be initiated based on a determination that the ratio exceeds a reference. In at least some embodiments, a wear-leveling of the first block BLK_1 of the first plane PLANE_1 may be initiated based on the determination that the data are degraded.

In at least one embodiment, in the case of performing an operation on any sub-block, the CDC manager may change an entry associated with a sister sub-block of the sub-block where the operation is performed. For example, the CDC manager may change a value corresponding to the performed operation in an entry ENT2 associated with the sister sub-block SB2 of the first sub-block SB1 where the operation is performed. That is, the CDC manager may change an entry associated with a sub-block corresponding to a victim in the CDC table 112C.

For example, referring to FIG. 17, when the secure erase operation is performed in the first sub-block SB1 of the first block BLK_1 of the first plane PLANE_1, the CDC manager may change a value corresponding to the special operation in entries of the CDC table, which correspond to the sister sub-blocks SB2, . . . , SBn of the first sub-block SB1 of the first block BLK_1 belonging to the first plane PLANE_1 of the first super block SBLK1. For example, the CDC manager may change a value corresponding to the special operation in the entry ENT2 of FIG. 15.

In this case, when the value of the entry ENT2 satisfies a preset condition, the memory controller may determine that data of the second sub-block SB2 of the first block BLK_1 of the first plane PLANE_1 are degraded. Alternatively, the memory controller may determine that there are degraded data of the first block BLK_1 in which the second sub-block SB2 of the first block BLK_1 of the first plane PLANE_1 is included. In at least one some embodiments, a determination that the data of the second block BLK_2 of the first plane PLANE_1 are degraded may initiate a detection of a ratio of detected error bits and a wear-leveling may be initiated based on a determination that the ratio exceeds a reference. In at least some embodiments, a wear-leveling of the second block BLK_2 of the first plane PLANE_1 may be initiated based on the determination that the data are degraded.

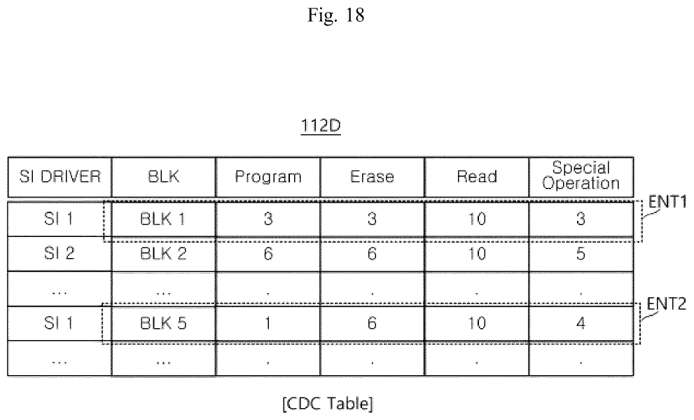

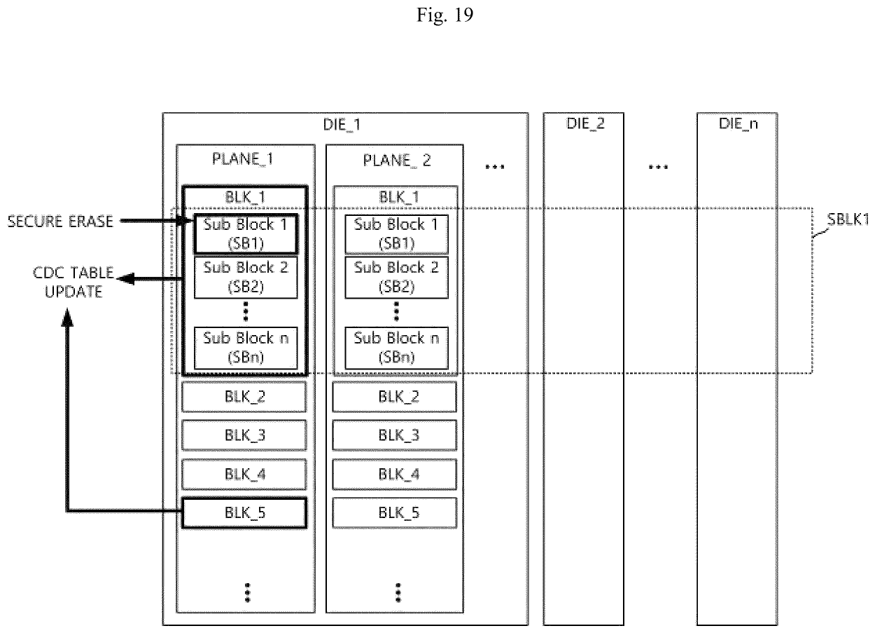

FIG. 18 is a diagram describing a configuration according to at least one embodiment of a CDC table. FIG. 19 is a diagram describing an example of changing a CDC table based on a CDC table of FIG. 18. A CDC table 112D of FIG. 18 may correspond to an example of the CDC table of the embodiments described with reference to FIGS. 1 to 10. FIG. 18 will be described as an example wherein the blocks BLK_1 and BLK_5 are supplied with a word line voltage from the same SI driver. Each of the blocks BLK_1 and BLK_5 may include a plurality of sub-blocks SB1 to SBn. At least one embodiment of the present disclosure will be described with reference to FIGS. 18 and 19.

Referring to FIG. 18, the CDC manager may manage a CDC table 112D in units of block. FIG. 18 is illustrated as an example wherein operations which cause the disturb include the program operation, the erase operation, the read operation, the special operation, and/or any combination therefore; but the present disclosure is not limited thereto.

In at least one embodiment, in the case of performing an operation on any sub-block, the CDC manager may change an entry associated with a block in which the sub-block where the operation is performed is included. When the sub-block in which the operation is performed is included in the block BLK_1, the CDC manager may change a value corresponding to the performed operation in the entry ENT1 associated with the block BLK_1.

For example, referring to FIG. 19, the first sub-block SB1 of the first block BLK_1 of the first plane PLANE_1 is included in the first block BLK_1 of the first super block SBLK1. Accordingly, when the secure erase operation is performed in the first sub-block SB1 of the first block BLK_1 of the first plane PLANE_1, the CDC manager may change a value corresponding to the special operation in the entry ENT1 of the CDC table, which corresponds to the first block BLK_1 of the first plane PLANE_1 of the first super block SBLK1.

In at least one embodiment, as described with reference to FIG. 7, the CDC manager may additionally change the CDC table of a block sharing the voltage provided to the word line of the sub-block where the operation is performed, based on the operation performed in the sub-block.

For example, referring to FIG. 19, the first sub-block SB1 of the first block BLK_1 of the first plane PLANE_1 is included in the first block BLK_1 of the first super block SBLK1. Referring to FIG. 18, the first block BLK_1 and the fifth block BLK_5 are provided with the word line voltage from the same SI driver. Accordingly, when the secure erase operation is performed in the first sub-block SB1 of the first block BLK_1 of the first plane PLANE_1, the CDC manager may change a value corresponding to the special operation even in the entry ENT2 of the CDC table, which corresponds to the fifth block BLK_5 of the first plane PLANE_1 of the first super block SBLK1.

When values of the entry ENT1 satisfy a preset reference, the memory controller may determine that data of the first block BLK_1 of the first plane PLANE_1 are degraded. When values of the entry ENT2 satisfy the preset condition, the memory controller may determine that data of the fifth block BLK_5 of the first plane PLANE_1 are degraded. In at least one some embodiments, a determination that the data are degraded may initiate a detection of a ratio of detected error bits for the corresponding block and a wear-leveling may be initiated based on a determination that the ratio exceeds a reference. In at least some embodiments, a wear-leveling of the corresponding may be initiated based on the determination that the data are degraded.

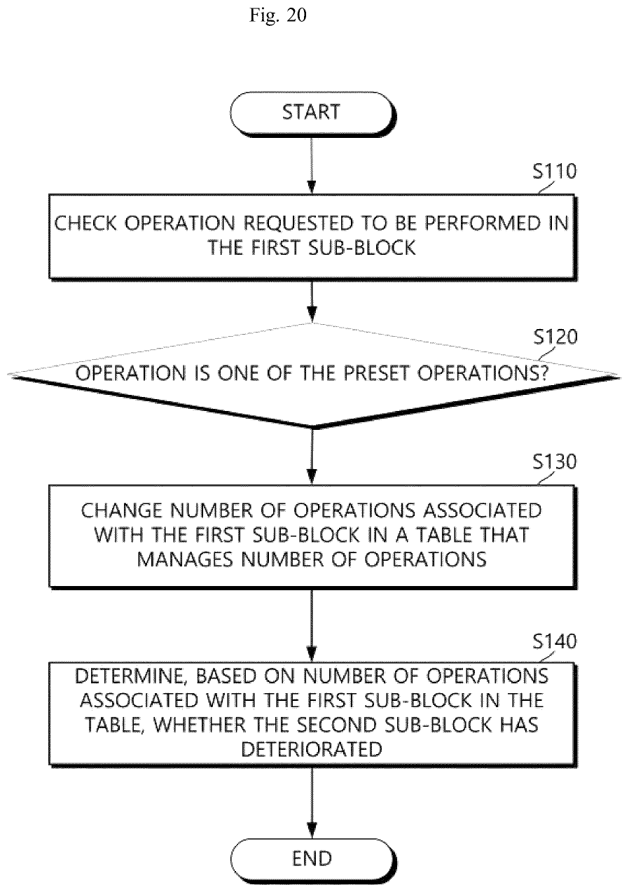

FIG. 20 is a flowchart illustrating an example of an operation of a storage device according to at least one embodiment of the present disclosure. The operating method of FIG. 20 may be performed, e.g., by the memory controller 110 of the storage device 100 of FIG. 1 and/or the memory controller 210 of a storage device 200 of FIG. 10.

The memory controller may check a command parsed from a packet received from the host or an internally generated command. The command may include an address of any sub-block and identification information of the command to be executed in the sub-block.

In operation S110, the memory controller may check an operation requested to be performed in the sub-block. For example, the memory controller may determine whether the operation to be performed in the sub-block is an operation set in advance as an operation causing the disturb in a sister sub-block. The operation causing the disturb may include the program operation, the erase operation, the special operation, etc.

When it is determined, in operation S120, that the operation to be performed in the sub-block is one of the operations, set in advance, as the operation causing the disturb, in operation S130, the memory controller may change the number of times of the operation in an entry of a CDC table, which is associated with the sub-block. As described with reference to FIGS. 13 to 19, entries associated with the sub-block may include an entry corresponding to the sub-block, an entry corresponding to a super block where the sub-block is included, an entry corresponding to a super block where the sub-block is included, and/or an entry corresponding to a sister sub-block of the sub-block.

In operation S140, when a specific entry satisfies a preset reference, whether data of at least one of a sub-block, a block, and a super block corresponding to the specific entry are degraded may be determined based on the CDC table. As described with reference to FIG. 1, when the degradation of data reaches a given level, the memory controller may reclaim data of at least one of the sub-block, the block, and the super block.

A storage device according to the present disclosure may mitigate and/or prevent the reduction of performance of the storage device.

The storage device according to the present disclosure may mitigate and/or prevent the degradation of performance due to the disturb caused in a block or any other sub-block when an operation on any sub-block is performed.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A storage device comprising:
a nonvolatile memory device including a plurality of memory blocks, the nonvolatile memory device configured to store and read data; and
a controller configured to control the nonvolatile memory device and to execute a data input request and a data output based on requests provided from a host,
wherein each of the plurality of memory blocks includes at least a first sub-block and a second sub-block, and
the controller is configured to determine whether data of the second sub-block are degraded, the determination based on a number of times an operation is performed in the first sub-block.

2. The storage device of claim 1, wherein the operation includes at least one of a program operation, an erase operation, a read operation, or a combination thereof.

3. The storage device of claim 2, wherein the operation includes a dummy code program operation and the program operation, and
the controller is configured to record a number of the dummy code program operations separate from a number of the program operations.

4. The storage device of claim 2, wherein the controller is configured to count the number of times the operation is performed in the first sub-block, and
wherein the count is based on the number of times the operation causes a change in data of the first sub-block.

5. The storage device of claim 2, wherein the controller is configured to count the number of times the operation is performed in a super block, the super block including first sub-, and
wherein the count is based on the number of times the operation causes a change in data of the first sub-block.

6. The storage device of claim 2, wherein the controller is configured to determine whether the data of the second sub-block are degraded, based on a result of applying different weights to the number program operations, the number of the erase operations, and the number of the read operations, respectively.

7. The storage device of claim 6, wherein the weights of the number of the program operations and the number of the erase operations are set to be higher than the weight of the number of the read operations.

8. The storage device of claim 2, wherein the controller is configured to record a number of special operations,
the number of the special operations is distinguished from the number of the program operations, the erase operations, and the read operations, and
the special operations include at least one of sanitize based on a nonvolatile memory express (NVMe), a purge operation on a Replay Protection Memory Block (RPMB) based on a universal flash storage (UFS), a secure erase operation, or a combination thereof.

9. The storage device of claim 8, wherein each of the plurality of memory blocks further includes a third sub-block sharing a bit line with the first sub-block and the second sub-block,
wherein the first sub-block is adjacent to the second sub-block, the second sub-block is adjacent to the third sub-block, and the third sub-block is not adjacent to the first sub-block, and
wherein the controller is configured to determine whether data of the third sub-block are degraded, based on the number of times the operation is performed in the first sub-block.

10. The storage device of claim 1, wherein the controller is configured to store the number of times the operation is performed in the first sub-block in a disturb table such that the disturb table corresponds to an address of the first sub-block.

11. The storage device of claim 1, wherein the controller is configured to store the number of times the operation is performed in the first sub-block in a disturb table such that the disturb table corresponds to an address of the second sub-block.

12. The storage device of claim 1, wherein the controller is configured to perform a read operation of the second sub-block, based on a result of comparing the number of times the operation is performed in the first sub-block to a preset condition.

13. The storage device of claim 12, wherein
the operation includes at least one of a program operation, an erase operation, a read operation, or a combination thereof, and
the controller is configured to store the number of the program operations and the number of the erase operations in a table during a performance of the operation on the first sub-block such that the number of the program operations and the number of the erase operations are distinguished from each other.

14. The storage device of claim 13, wherein the controller is configured to:
perform a read operation of a least significant bit (LSB) page of the second sub-block based on a result of comparing the number the program operation to a first threshold value; and
perform a read operation of a most significant bit (MSB) page of the second sub-block based on a result of comparing the number the erase operation to a second threshold value.

15. The storage device of claim 12, wherein the controller is configured to:
perform a read operation of a least significant bit (LSB) page of the second sub-block based on a determination a first condition has been met; and
perform a read operation of a most significant bit (MSB) page of the second sub-block based on a determination a second condition, different from the first condition, has been met.

16. The storage device of claim 1, wherein the controller is configured to perform a read operation of blocks based on a result of comparing the number of the operation performed in one of the first sub-blocks to a preset threshold value,
the blocks sharing a voltage provided to a word line of the one first sub-block.

17. The storage device of claim 16, wherein the controller is configured to determine whether data of a first block, sharing the voltage to be provided to the word line of the one first sub-block, are degraded based on the operation performed in the one first sub-block, and
wherein the one first sub-block is separate from the first block.

18. The storage device of claim 1, wherein each of the memory blocks is divided in units of sub-block in an erase operation,
wherein the storage device further comprises a row decoder configured to select a sub-block targeted for the erase operation.

19. A storage device comprising:
a memory device including a plurality of memory blocks; and
a controller configured to control the memory device,
wherein each of the plurality of memory blocks includes a plurality of sub-blocks, and
wherein the controller is configured to determine whether data of a sub-block, from among the plurality of sub-blocks, are degraded based on a number of times an operation is performed on another sub-block from among the plurality of sub-blocks.

20. An operating method of a storage device, comprising:
checking an operation requested to be performed in a first sub-block;
changing, when the operation is one of preset operations, a value, representing a number of times the operation is performed in associated with the first sub-block, in a table; and
determining whether data of a second sub-block are degraded based on the number of times the operation associated with the first sub-block is performed,
wherein the first sub-block and the second sub-block are separate sub-blocks included in a same block.
